(19) United States
(12) Patent Application Publication
(10) Pub. No.: US 2004/0044789 A1
(43) Pub. Date: Mar. 4, 2004

(54) Dynamic service-aware aggregation of PPP sessions over variable network tunnels

(75) Inventors: Eli Angel, Raanana (IL); Dror Bar-Or, Yehud (IL); David Berechya, Tel Mond (IL); Eran Levi, Tel Aviv (IL); Eitan Mardiks, Ra'anana (IL); Zvika Weinshtock, Hod-Hasharon (IL)

Correspondence Address: FITCH EVEN TABIN AND FLANNERY, 120 SOUTH LA SALLE STREET, SUITE 1600, CHICAGO, IL, 60603-3406, US

(73) Assignee: SEABRIDGE LTD.

(21) Appl. No.: 10/385,889

(22) Filed: Mar. 11, 2003

Related U.S. Application Data
(60) Provisional application No. 60/363,236, filed on Mar. 11, 2002.

(51) Int. Cl. G06F 15/173

(52) U.S. Cl. 709/238

(57) ABSTRACT

A system for use in a transport network that connects to the Internet or to a similar IP network, by which the class of service and Quality of Service of the connection to the Internet over the transport network may be dynamically adjusted to meet changing requirements. In contrast to static systems which require manual reconfiguration to change the class of service, a system according to an embodiment of the present invention provides for on-demand changing of the class of service depending on the current needs. A set of tunnels from the transport network's first switch (the “aggregator” or the DSLAM) to the interface between the transport network and the IP network (the “edge router”) is pre-configured to provide the different levels of service that are supported. By selecting the appropriate tunnel through which the connection is made at the time the session is established, dynamic selection of Class of Service, and hence Quality of Service, is effected. Each tunnel can conduct multiple PPP sessions having the same Class of Service. A variety of selection methods are provided, depending on the particulars of the access/transport network. The invention realizes substantial advantages by utilizing PPP over Ethernet (PPPoE) as an alternative to the Layer 2 Tunnel Protocol currently in use for tunnels.

This application claims priority to U.S. provisional application No. 60/363,236 filed Mar. 11, 2002, which is incorporated herein by reference in its entirety.

### FIELD OF THE INVENTION

The present invention relates to network connections, and, more particularly, to providing a dynamically-variable Quality-of-Service across Internet access/transport networks.

### BACKGROUND OF THE INVENTION

Emerging Internet Protocol (IP) services are popular services offered by telecom companies, Internet Service Providers (ISP's), and content providers. With competition forcing prices lower, network operators face the challenge of leveraging their existing network infrastructure to minimize capital expenditure and reduce operational costs, while implementing and delivering premium services to generate new revenue streams. IP services are diverse and include services such as: Internet access; Virtual Private Network (VPN); interactive video conferencing; and entertainment, such as multi-channel broadcast TV, real-time video and audio streaming; Video on Demand (VoD), on-line multi-player gaming, and other multimedia applications.

The penetration of broadband communications into the residential market enables telecom providers (operators of access/transport networks) to offer this variety of premium IP services to increase their revenues. Unlike “best effort” Internet browsing, however, these services require strict, differentiated levels of Quality-of-Service (QoS), featuring control over parameters such as bandwidth. Ideally, the level of service should be allocated dynamically for each session on demand, for any particular service to individual subscribers.

Today's Digital Subscriber Line (DSL) access networks, however, are optimized to deliver fast Internet service only with a “best-effort” treatment. They utilize a static Asynchronous Transfer Mode (ATM)-based architecture employing Permanent Virtual Circuits (PVC's) to transport subscriber traffic to the IP network. Each subscriber is interconnected with a static connection to the Broadband Remote Access Servers (BRAS) or service router, optimized for “best-effort” services.

Access Technologies

The traditional narrow-band access based on a modem (Modulator/Demodulator) and a plain telephone line cannot satisfy the requirements for the new IP services for two main reasons

1. Bandwidth (BW) is limited to 56 Kb/s.

2. The customer must connect to the ISP by dial-up, and when connected, the telephone line is busy and cannot be used for other purposes. Hence, narrow band access is not considered to be an “always-on” service.

In contrast, the new broadband access addresses the requirement for the new IP services. The bandwidth range is between 128 Kb/s up to 26 Mb/s downstream traffic per subscriber, and 64 Kb/s up to 13 Mbit/s upstream traffic per subscriber, depending on the technology.

The technologies used for broadband Internet access are Digital Subscriber Line (DSL) or cable TV. DSL technology uses telephone lines, but unlike narrow band access, the DSL modem does not hold the line busy, so that telephone calls can be made during the Internet connection. Hence broadband access is considered as “always-on” service. Besides broadband access based on telephone lines and cable TV, there are new access technologies based on Fiber to The Home, Ethernet, and, other high-bandwidth technologies.

The need for dynamic selection of service is found principally, but not exclusively, in broadband access and in another high-bandwidth access environments.

Access Network Architecture

FIG. 1 illustrates a typical architecture common to most access networks. A customer workstation 10 is connected to a DSL modem 11 via Ethernet, Universal Serial Bus (USB), or any other suitable interface; modem 11 transmits and receives the user traffic over the DSL. In practice, workstation 10 is often a personal computer (PC).

A DSL Access Multiplexer (DSLAM) 12 terminates the DSL lines and multiplexes user traffic over a network uplink. Suitable protocols for uplink technologies include, but are not limited to: ATM over Synchronous Digital Hierarchy/Plesiochronous Digital Hierarchy (SDH/PDH); Ethernet 100M or GbE.

A transport network 14 connects DSLAM 12 to an edge router 15. DSLAM 12 is typically located in a local Central Office (CO) or in street cabinets, whereas edge router 15 is typically located in the regional CO.

Most of the existing transport networks deployed by the telecom companies are ATM and Synchronous Optical Network/SDH (SONET/SDH). Besides ATM, there are emerging transport technologies based on MPLS, Resilience Packet Ring (RPR), and Ethernet. All of these transport technologies can benefit from dynamic selection of Quality of Service, and the present invention is not limited to any particular transport technology.

Access Protocols

The access protocol is the protocol between the user and the edge router. There are a number of diversity-of-access protocols, including, but not limited to: Point-to-Point Protocol (PPP); PPP over Ethernet (PPPoE); Ethernet; IP over Ethernet; and Multi-Protocol Label Switching (MPLS). Networks utilizing such protocols will benefit from dynamic QoS selection.

The main tasks of edge router 15 are:

1. User authentication, authorization, and accounting. User information is stored in a Remote Authentication Dial-In User Service (RADIUS) database 16.

2. Edge router 15 terminates the PPP or PPPoE encapsulation and marks the boundary of the IP network. In other cases, an edge router in the Network Access Provider (NAP) aggregates the PPP sessions over a Layer 2 Tunnel Protocol (L2TP) tunnel towards the ISP's edge router.

An aggregator 13 is the first switch in the transport network, to which DSLAM 12 is connected. Aggregator 13 has ports for connecting, via the access network to a multiplicity of user workstations, and ports for connecting, via the transport network, to at least one edge router 15.

Currently, there are limitations of the prior art caused by the need for a configuration that features either a connection-oriented path (such as a Virtual Circuit) for each user or a switched-connection oriented path (such as ATM SVC). The drawback of the former approach is the resulting large number of VC's connected to the edge router—the number of VC's equals the number of customers multiplied by the Classes of Service (CoS). Large number of VC's to the edge router increases the operational expenditures (OPEX) as well as the capital expenditures (CAPEX), because the number of VC's per edge router is limited. The latter approach utilizing a switched connection-oriented path avoids this problem, but not all of the deployed ATM networks support SVC. The result is that the assignment of service in access/transport networks is today done by a static, manual configuration process rather than by a dynamic, automatic configuration process. This restricts the usability and efficiency of access/transport networks, and, as a consequence, the usability and efficiency of Internet connections made via these access/transport networks.

There is thus a need for, and it would be highly advantageous to have, a system which can dynamically assign and change the class of service for Internet access/transport networks, and in a way that allows operators to make maximum use of their existing infrastructure. This goal is met by the present invention.

### SUMMARY OF THE INVENTION

The present invention allows the user to select desired level of service and ensures end-to-end Quality of Service, allocated dynamically and on demand, according to the specific preferences and requirements of the service and the user, while utilizing an existing network infrastructure.

In addition, a method provided by an embodiment of the present invention gives the operator better control of network traffic and loads, as well as a breakdown of the network services consumption using traffic engineering tools that monitor network performance for fine-tuning.

Furthermore, embodiments of the present invention simplify and speed the provisioning process, thereby eliminating bottlenecks by separating the user's network provisioning from the service provisioning. On the user's side, the operator can utilize mass configuration tools to quickly connect users to the broadband network regardless of the services they will subscribe to later on. On the network side, the operator manages service-class-oriented aggregates rather than large numbers of specific users' connections.

The present invention achieves these objectives with intelligent service-aware aggregation for the access/transport network. Employing a unique multi-layer aggregation mechanism, the invention efficiently provides the required bandwidth to individual users, and maps service and user profiles into the transport network. The invention enforces differentiated QoS levels end-to-end. As a result, the method transforms the existing static ATM access network into an intelligent, service-optimized environment that provides the desired QoS treatment dynamically and on demand, according to the user's specific preferences and requirements.

The present invention eliminates the problems of large number of connection-oriented paths such as VC's in ATM or Labeled Switch Paths (LSP's) in Multi Protocol Label Switching (MPLS) by the use of small number of tunnels that traverse the transport network. Each tunnel can carry many users sessions. By reducing the number of connection-oriented paths the following advantages are achieved:

1. Decreased operational expenditures (OPEX) for the operators; and

2. Decreased capital expenditures (CAPEX) for the operators, by limiting the number of connection-oriented paths supported by edge routers.

Tunnels

Embodiments of the present invention are implemented in an existing device within the access/transport network. This device can be aggregator 13 or DSLAM 12. For simplicity, the non-limiting examples presented in the text and drawings herein are presented with the device as the aggregator, but it is to be understood that the examples can also have the implementing device as the DSLAM, although the connections from DSLAM 12 to the transport network may pass through aggregator 13 and are therefore indirect (FIG. 1). Embodiments of the present invention use tunnels to connect aggregator 13 (or DSLAM 12, as just indicated) to edge router 15 (FIG. 1). Doing so overcomes the previously-discussed prior-art limitations requiring either the high expense incurred by excessive numbers of oriented paths (for example, a VC for each user), or switched connection-oriented paths (for example, ATM SVC) which are not supported by all deployed ATM networks.

According to the present invention, there is a set of tunnels from the aggregator to each edge router. Each network tunnel carries multiple PPP sessions within the same class of service. Each tunnel has the appropriate QoS parameters to guarantee the QoS requirements for the session.

For each tunnel there is a connection-oriented path. Technologies to implement this path include, but are not limited to, LSP in MPLS, and VC in ATM. In this manner, there are only a small number of VC's from the aggregators to the edge router.

It will be appreciated that a system according to the present invention may be a suitably-programmed computer, and that methods of the present invention may be performed by a suitably-programmed computer. Thus, the invention contemplates a computer program product that is readable by a machine, such as a computer, for emulating or effecting a system of the invention, or any part thereof, or for performing a method of the invention, or any part thereof. The term “computer program” herein denotes any collection of machine-readable codes, and/or instructions, and/or data residing in a machine-accessible storage, including, but not limited to memory and storage media, and executable by a machine for emulating or effecting a system of the invention or any part thereof, or for performing a method of the invention or any part thereof.

Therefore, according to the present invention there is provided, in an IP service broadband access/transport network, a device including: (a) a first set of ports for establishing user-side connections, via an access network, to a plurality of user workstations; and (b) at least one second port for establishing a network-side connection, via a transport network, to at least one edge router for accessing the IP service, the network-side connection including a plurality of tunnels, each tunnel of which is designated for a unique quality of service, the plurality of tunnels configured to employ PPPoE, the tunnels configured to aggregate a plurality of PPP sessions per tunnel, and each tunnel being associated with a connection-oriented path; the device being operative to dynamically allocating quality of service by dynamically connecting a connected user to the at least one edge router via a tunnel selected one from the plurality of tunnels.

Furthermore, according to the present invention there is also provided a method for setting up a session for a user over an access/transport network having a plurality of tunnels, wherein the session has a required quality of service and wherein each tunnel of the plurality of tunnels has a specific class of service associated with a specific quality of service, the method including: (a) determining the required quality of service; (b) selecting a tunnel from the plurality of tunnels, such that the selected tunnel has a class of service appropriate to the required quality of service; and (c) connecting the user session to the selected tunnel.

Moreover, according to the present invention there is also provided a method for obtaining a request for a desired quality of service at the time of setting up a session for a user, the method including: (a) initiating setup of the session; (b) while the session is being set up, making an identification of the characteristics of the desired quality of service; and (c) receiving the identification.

In addition, according to the present invention there is also provided a system for notifying a user of a rejection of a session, the system including: (a) a plurality of tunnels; and (b) a tunnel of the plurality dedicated to conveying a rejection message to the user.

### BRIEF DESCRIPTION OF THE DRAWINGS

The invention is herein described, by way of example only, with reference to the accompanying drawings, wherein:

FIG. 1 illustrates access/transport network architecture.

FIG. 2A illustrates an access/transport network configured by prior-art static provisioning.

FIG. 2B illustrates an access/transport network configured by dynamic service selection according to an embodiment of the present invention.

FIG. 3 is a process diagram illustrating session setup process with PPP for user access.

FIG. 4 is a process diagram illustrating a first embodiment of session setup process with PPPoE for user access.

FIG. 5 is a process diagram illustrating a second embodiment of session setup process with PPPoE for user access.

FIG. 6 illustrates three modes of aggregation according to an embodiment of the present invention.

FIG. 7 is a protocol stack diagram for the network tunnels.

FIG. 8 illustrates portal-based service selection.

### DESCRIPTION OF THE PREFERRED EMBODIMENTS

The principles and operation of a system according to the present invention may be understood with reference to the drawings and the accompanying description.

An embodiment of the present invention uses PPP over Ethernet (PPPoE, as referenced in Internet Engineering Task Force RFC2516) as a technique for multiplexing many Point-to-Point Protocol (PPP) sessions in a single network tunnel. This differs fundamentally from prior-art methods that use the Layer 2 Tunnel Protocol (L2TP) technique for the same purpose, as referenced in “Layer Two Tunneling Protocol—L2TP”, Internet Engineering Task Force RFC2661. An embodiment of invention realizes important advantages by utilizing PPPoE instead of L2TP as a multiplexing layer in the access environment. These advantages include:

1. PPPoE is a much simpler protocol than L2TP.

2. Because PPPoE is an access method, most of the edge routers support PPPoE in the user-side interface.

3. Using L2TP in access networks requires substantial changes to the service delivery structure. This is why network operators, in most cases, do not use L2TP in the access network. Embodiments of the present invention, however, allow operators to use aggregation with minimal changes to the access environment. This feature is referred to as “transparency”.

Dynamic Service Selection

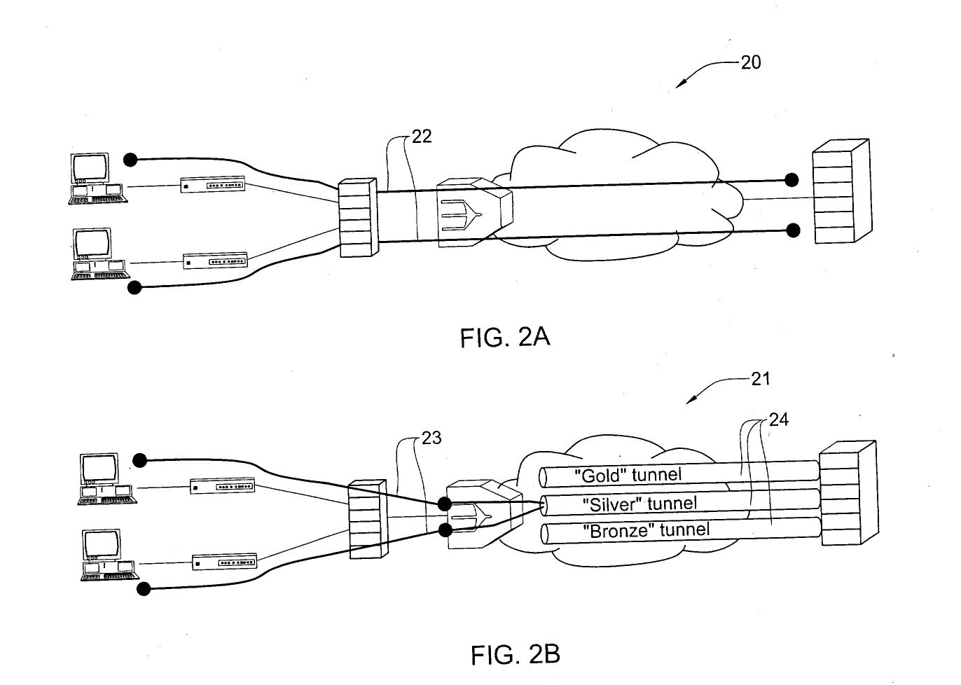

FIG. 2B illustrates an access/transport network 21 according to an embodiment of the present invention, whereas in contrast, FIG. 2A illustrates a typical prior-art access/transport network 20 as is currently found in the industry.

Most of the current transport networks deployed by telecom companies are ATM networks. In prior-art network 20 users are connected directly to the edge router by a PVC 22. This type of connectivity requires provisioning, and is not dynamic. In the provisioning phase, the user contacts the desired ISP (such as by telephone) and negotiates or requests the desired QoS. Provisioning requires a manual intervention by the operator. After the provisioning phase, any change in the ISP or in the QoS requires another manual intervention by the operator.

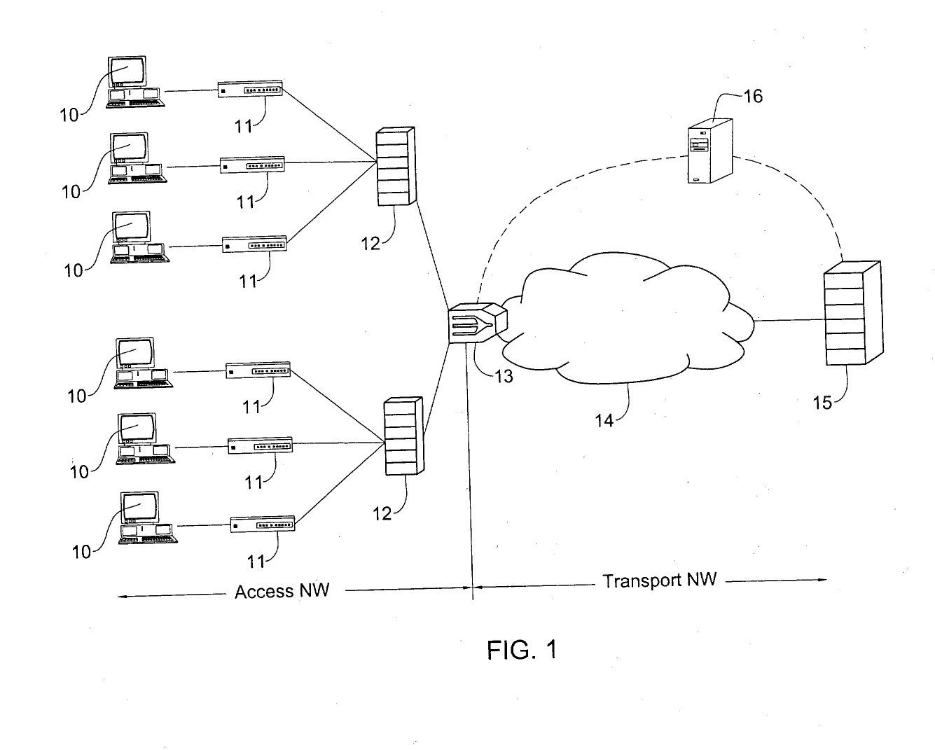

Embodiments of the present invention offer an alternative approach to provisioning. The customer is connected to the aggregator 13 (FIG. 1) by ATM PVC 23, or by other means, such as PPPoE.

Aggregator 13 or DSLAM 12 (FIG. 1) is connected to edge router 15 (FIG. 1) by a set of pre-provisioned tunnels 24. According to an embodiment of the present invention, set 24 includes a tunnel for each supported Class of Service (CoS). By having a dedicated tunnel for each CoS, a specified level of QoS is thereby guaranteed for the user's session. The eligible technologies for the tunnels include, but are not limited to ATM VC's and MPLS LSP's.

When a new session is set up, aggregator 13 or DSLAM 12 dynamically connects the user to the appropriate tunnel. The user can dynamically choose the ISP and the service with respective QoS parameters.

Building Blocks

Dynamic service-aware aggregation according to embodiments of the present invention has the following main elements:

Inspection—Incoming subscriber traffic is identified and categorized according to pre-defined criteria, in order to understand the required destination and QoS requirements.

Classification—Based on the inspection, the session is classified, and the following attributes are obtained:

Traffic parameters, such as: QoS, and bandwidth

The associated network tunnel. The tunnel connects the user's session to the desired service platform. The tunnel has appropriate QoS parameters to satisfy the user's demand.

Session Admission Control—Sessions are accepted according to acceptance rules that consider bandwidth availability as well as the ability of the system to satisfy the user's demand for QoS.

Bandwidth Enforcement—Based on the inspection, the aggregator enforces the user's bandwidth consumption by policing and shaping mechanisms.

Forwarding—Traffic has a frame format, and each frame has a header that contains forwarding information. This information is used to forward the session into the appropriate network tunnel. The forwarding method is determined according to the user's session type and the aggregation method.

Aggregation—Several sessions from the same class of service can be aggregated into the same network tunnel, using PPPoE.

It is noted, however, that the present invention is not bound by the particular architecture associated with the above building blocks. For example, one or more of the above-specified modules may be modified, or others may be added as required, depending on the particular application.

Inspection

This section deals with the inspection criteria required by the present invention, taking into account the strong influence of the techniques used on the transparency of the invention.

PPP for Subscriber Access

Inspection relies on the username and the Fully Qualified Domain Name (FQDN), which appears in the username string during the authentication phase. This value indicates the required ISP and optionally the required service and QoS. The aggregator or DSLAM performs proxy Line Control Protocol (LCP) as defined in the “Point-to-Point Protocol (PPP)”, Internet Engineering Task Force RFC1661 in order to get the user name and FQDN. After the inspection process, the user restarts again the PPP session towards the edge router. Thus, the PPP session is established between the user and the edge router, and the aggregator is transparent both to the user and to the edge router.

PPPoE for Subscriber Access

In the case where PPPoE is used for subscriber access, it is possible to use either of two inspection methods:

1. The same inspection method as used for PPP may be used for the classification process. In this case, the aggregator performs PPPoE termination (to start the PPP LCP phase), followed by proxy LCP, as described above, in order to retrieve the FQDN.

2. Alternatively, there is an option to use the information that appears in the PPPoE Service-Name tag in order to map the user session to the appropriate service.

Other Access Protocols

For certain applications, such as applications where there is no setup process, inspection is not needed, because forwarding can be based on protocol state information. In Ethernet, for example, the forwarding is done according to the header information.

Session Admission Control

One of the most important tasks of the aggregator is to guarantee the required QoS. The aggregator does this by calculating the available bandwidths in the tunnels and on the user's side of the line, and then comparing these against the bandwidth needed for the QoS. Based on this, the aggregator may be able to select an appropriate tunnel to the edge router from among a set of tunnels between the aggregator and the edge router, where the tunnels in the set each have specific capacities and specific QoS parameters (such as loss ratio, delay, and delay variation). Thus, when a new session is set up, the aggregator performs the following calculations:

1. Tunnel Call Admission Control (CAC) to determine if the required bandwidth is available in a particular tunnel; and

2. User Side CAC to determine if the required bandwidth is available in the user line (the line on the user's side).

Only if there is available bandwidth in the tunnel and also in the user line is the session allowed. Otherwise, the session is rejected.

Session Setup for User Access via PPP

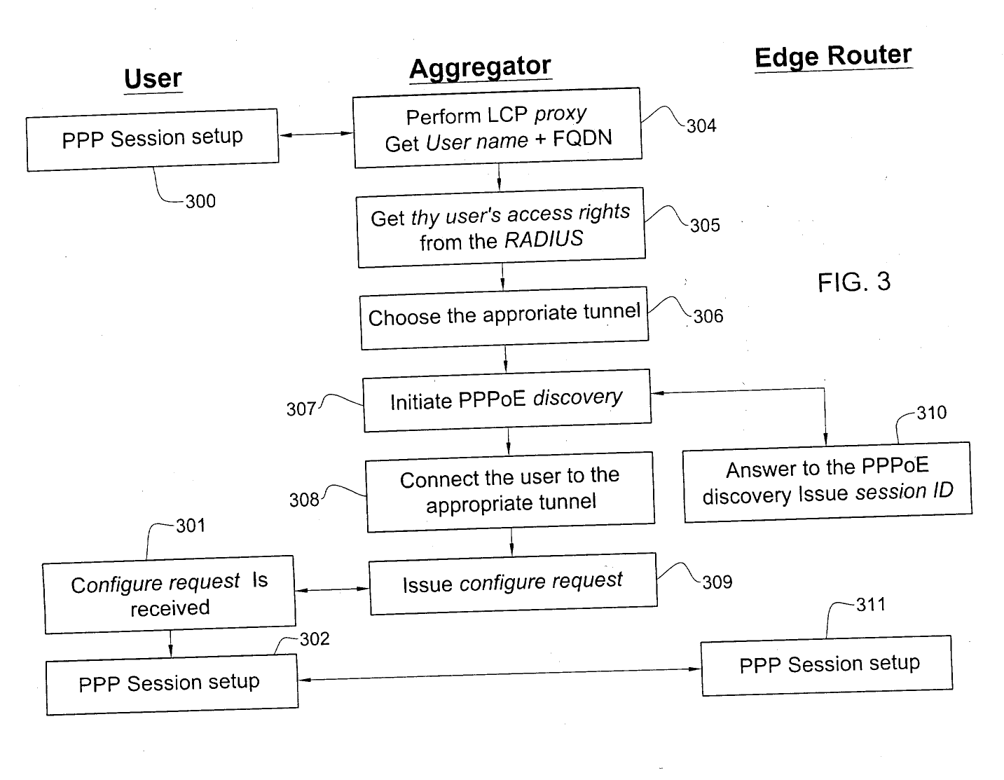

FIG. 3 is a process diagram illustrating session setup in the case where PPP is the user access protocol. In a session startup step 300, the user starts the PPP session to an aggregator, which acts as an LCP proxy in a step 304. The first phase of this is Line Control Protocol (LCP), followed by Password Access Protocol (PAP) or Challenge Access Protocol (CHAP). During the setup process the user provides the username and FQDN, which contains information about the required service, the required service provider, and the required QoS.

In a step 305 the aggregator uses the username to identify the user and the access rights. The user's information is stored in a database located in RADIUS server, and the aggregator uses the FQDN to obtain the user's requirements. In a step 306, the aggregator chooses the appropriate tunnel to the appropriate edge router. In a step 307, the aggregator acts as PPPoE client and initiates PPPoE discovery to the edge router, and in a step 310 the PPPoE discovery results in the issue of a session ID. In order to act as PPPoE client, the aggregator needs an Ethernet source Media Access Control (MAC) address, and for this purpose there is a pool of MAC addresses, one MAC address of which is used per tunnel. The aggregator then receives the session ID from the edge router, and uses this session ID to transmit the user PPP over the network tunnel.

In a step 308 the aggregator connects the user to the appropriate tunnel. Once the connection between the user and the edge router is in place, the aggregator asks the user to set up the PPP session again. In a step 309, the aggregator issues the PPP-LCP command configure request, which is received by the user in a step 301.

In a step 302 the user again sets up the PPP to the edge router, without involvement of the aggregator. Because the edge router is unaware of the previous steps, this process is considered to be PPP-transparent to the edge router.

Session Setup Where the User Access is PPPoE—FQDN Inspection

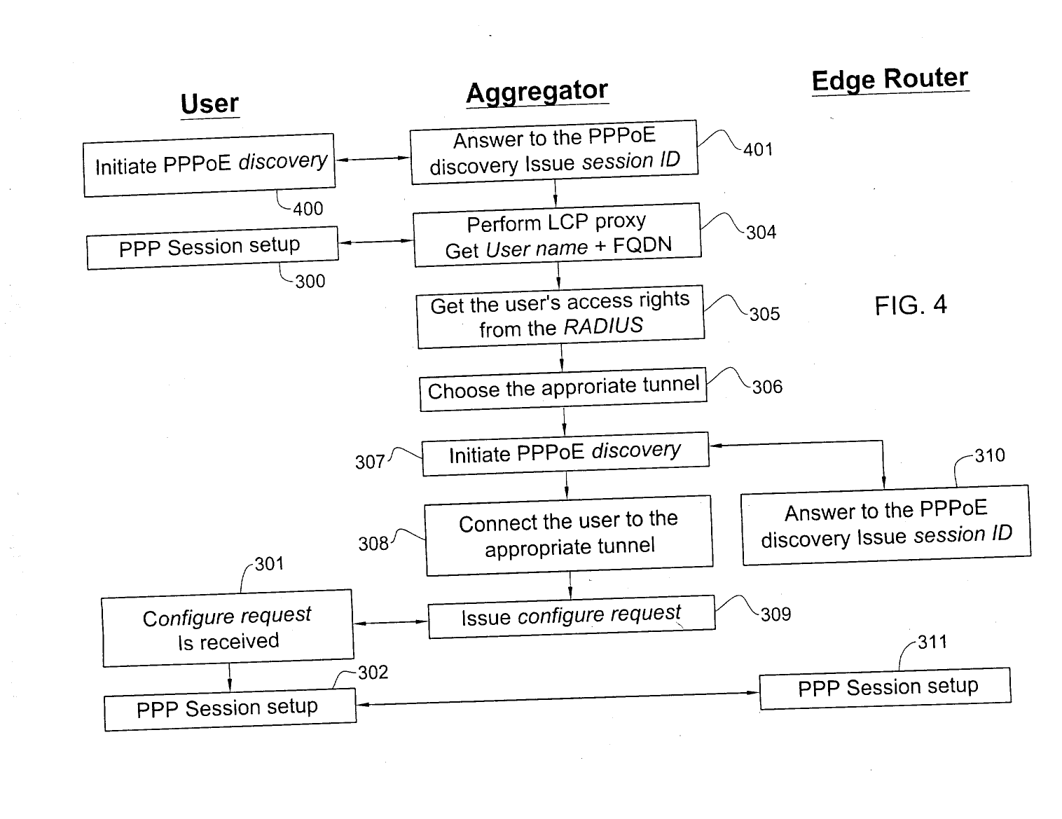

FIG. 4 is a process diagram illustrating a first embodiment of a session setup process with PPPoE for user access. In a step 400, the user starts the PPPoE discovery to the aggregator, which acts as a PPPoE server in a step 401, and terminates the PPPoE layer. The rest of the process in this case is same as that described above and illustrated in FIG. 3.

Session Setup Where the User Access is PPPoE—Service Tag Inspection

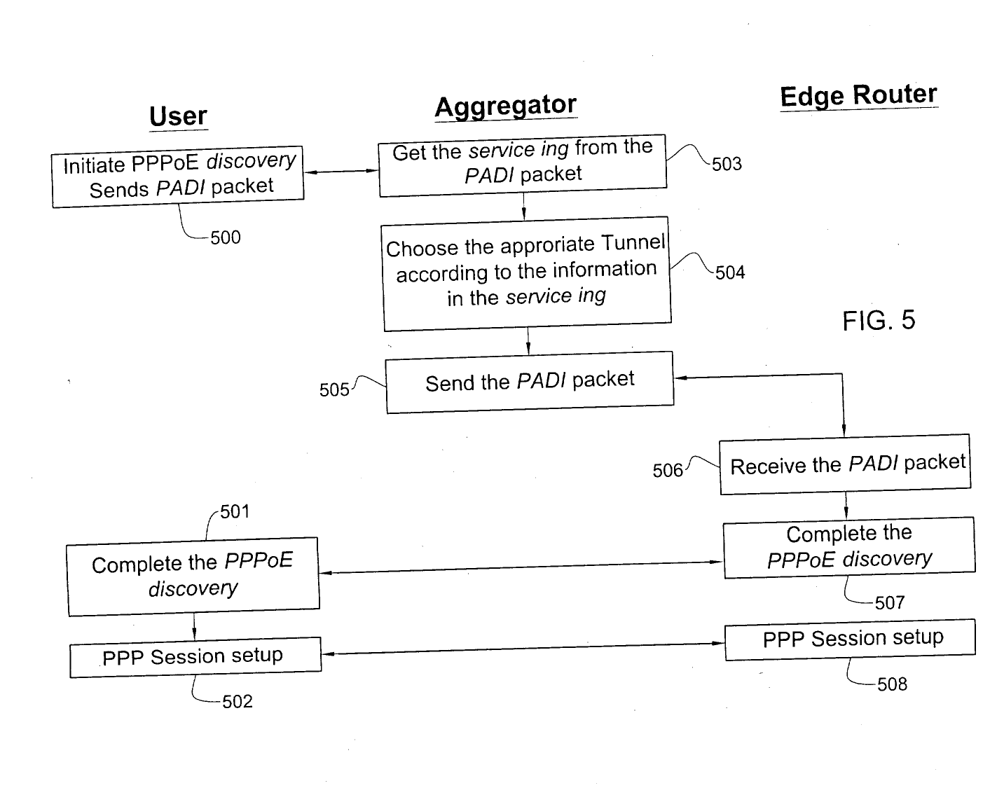

FIG. 5 is a process diagram illustrating a second embodiment of a session setup process with PPPoE for user access. In a step 500 the user starts PPPoE discovery by sending a PPPoe Active Discovery Initiation (PADI) packet containing a service tag, and in a step 503, the aggregator gets this packet. The service tag may contain information regarding to the required service, service provider, and QoS.

In a step 504, the aggregator uses the information from the service tag to choose the appropriate tunnel to the appropriate edge router. In a step 505, the aggregator transmits the PADI packet to the edge router over the chosen tunnel. From this point onward, the aggregator no longer participates in the traffic flows between the user and the edge router. This process is therefore totally transparent to the user and to the edge router. In a step 506 the edge router receives the PADI packet. In a step 507 the PPPoE discovery procedure is completed on the edge router's side, and in a step 501 the PPPoE discovery is completed from the user's side. Finally, in a step 502 the user initiates PPP session towards the edge router.

QoS Enforcement

QoS enforcement needed for controlling user bandwidth consumption as well as for network planning and engineering.

Traditionally, QoS enforcement is performed in the DSLAM by static configuration, but when users are allowed to dynamically select their service by changing QoS parameters, it is necessary to enforce those QoS parameters dynamically.

In an embodiment of the present invention, the aggregator enforces the QoS by using policer and its shaper mechanisms. After inspection, the aggregator sets policer and shaper parameters according to the service QoS. Here, it is the aggregator, not the DSLAM, which enforces the QoS.

Forwarding

A forwarding process is performed for each packet that arrives at the aggregator. In this process the aggregator chooses an output port and an output tunnel for each packet. Since PPP does not contain forwarding information, the lower layers such as PPPoE, Ethernet, or ATM, are used.

Two transport network technologies, ATM and MPLS are mentioned in the non-limiting examples below. The present invention is not limited to those two protocols, however. ATM and MPLS were chosen as examples because they are the most common protocols used in transport.

Forwarding Tables

Table 1 details the forwarding where the incoming protocol is PPP over ATM and the transport network is ATM.

TABLE 1
Forwarding table for PPPoA to ATM

Output Parameters

| Input Parameters | PPPoE encapsulation | Destination |
|---|---|---|
| Port, VPI/VCI | SA, DA, Session ID | Port, VPI/VCI |

Table 2 details the forwarding where the incoming protocol is PPP over ATM and the transport network is MPLS.

TABLE 2
Forwarding table for PPPoA to MPLS

| | Output Parameters | | | | |
|---|---|---|---|---|---|
| Input Parameters | PPPoE encapsulation | Destination | | | |
| Port, VPI/VCI | SA, DA, Session ID | Port | Tunnel LSP | VC Label | Next hop |
| | | | | | IP address |

Table 3 details the forwarding where the incoming protocol is PPPoE and the transport network is MPLS.

The input parameters are Ethernet SA (Source Address), DA (Destination Address) and PPPoE Session ID. The output parameters include destination (port, Tunnel LSP, VC label, next hop IP address) and encapsulation parameters PPPoE, SA, DA, Session ID.

TABLE 3
Forwarding table for PPPoA to MPLS

| | | Output Parameters | | | |
|---|---|---|---|---|---|
| Input Parameters | PPPoE encapsulation | Destination | | | |
| SA, DA, | SA, DA, Session ID | Port | Tunnel LSP | VC Label | Next hop |
| Session ID | | | | | IP address |

Aggregation

Aggregation allows transmitting and receiving multiple PPP sessions over a single tunnel. The common prior-art method for PPP aggregation is L2TP. The main drawback of L2TP, as previously mentioned, is the complexity.

Embodiments of the present invention utilize PPPoE as the aggregation layer. The originally-intended purpose of PPPoE is to connect many hosts to a single server over Ethernet. In PPPoE, therefore, hosts are the originators. In an embodiment of the present invention, it is the aggregator as a network node that originates the PPPoE.

Aggregation Modes

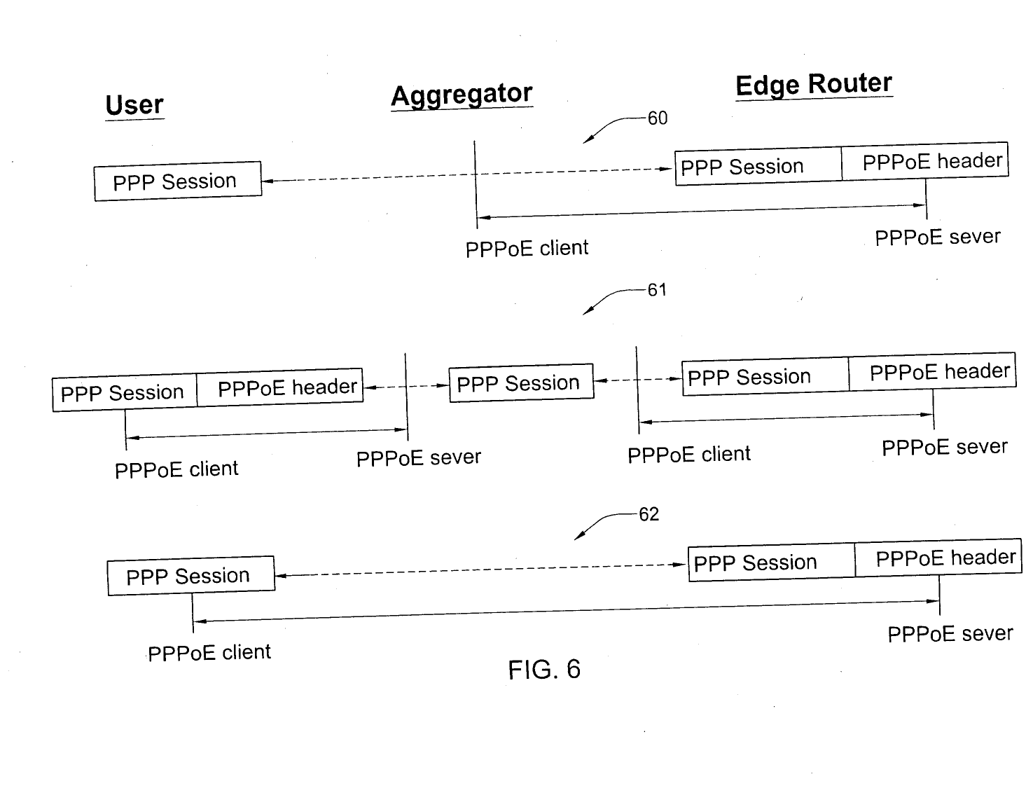

In embodiments of the present invention there are defined three modes of aggregation, as illustrated in FIG. 6. Not all embodiments of the present invention necessarily utilize one of these modes, however.

PPPoE Client Mode

In the PPPoE host mode the user access method is PPP, such as PPP over ATM (which is a popular access method in the ADSL technology). In a PPPoE client mode 60, the aggregator encapsulates the PPP into a PPPoE frame and plays the role of the PPPoE client. The aggregator has a MAC address pool, and takes the SA from that address pool. In general, the aggregator uses one SA for a tunnel. The DA is the edge router Ethernet address, and the session ID is given by the edge router in the session setup.

PPPoE Proxy Mode

In a PPPoE proxy mode 61 the user access method is PPPoE. In this case the aggregator terminates the PPPoE session from the user, and plays the role of PPPoE server. Then the aggregator encapsulates the PPP session again towards the edge router and plays the role of PPPoE client. The aggregator takes the SA from its own MAC address pool. In general, the aggregator uses one SA for a tunnel. DA is the edge router Ethernet address and session ID is a number given by the edge router in the session setup.

PPPoE Relay Mode

In a PPPoE relay mode 62 the user access method is PPPoE. The aggregator does not participate in the PPPoE, and serves to aggregate multiple PPPoE sessions over a single tunnel without any changes in the PPPoE frame. The PPPoE session itself is strictly between the user and the edge router.

Tunnel Protocols

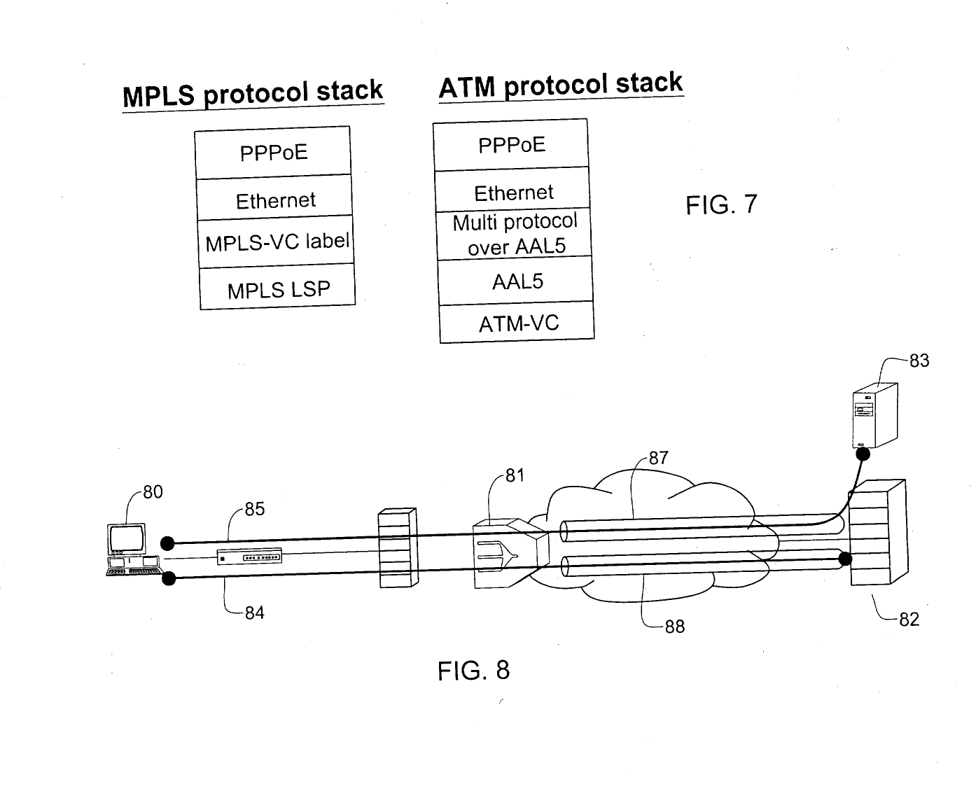

FIG. 7 illustrates the protocol stacks for MPLS and ATM tunnels, as described below.

MPLS Tunnels

In an embodiment of the present invention, L2 over MPLS is utilized, as shown in FIG. 7. The protocol stack from top to bottom is:

1. PPPoE.

2. Ethernet over MPLS, MPLS VC label.

3. MPLS Tunnel label.

ATM Tunnels

Another embodiment of the present invention is based on ATM tunnels. ATM tunnels are VC's, and can carry PPPoE by using the following protocol stack from top to bottom, as shown in FIG. 7:

1. PPPoE.

2. Ethernet over Multi-protocol over ATM (as referenced in Internet Engineering Task Force RFC2684).

3. ATM Adaptation Layer 5 (AAL5).

Implementation Issues

One of the steps in an embodiment of the present invention involves splitting between inspection and control on one side, and forwarding and packet processing on the other side. The forwarding and packet processing is done by hardware at the in-line rate, while inspection and control done by software.

User Service Selection

The following sections describe how the user may select the desired class of service (and hence the Quality-of-Service), and how the aggregator informs the user and the edge router of service rejection (for example, because of inadequate available bandwidth).

In all cases, the desired Quality of Service must be identified and this identification must be received by the device performing tunnel selection (such as the aggregator or DSLAM, as previously noted).

Methods for User Service Selection

The user can choose the ISP and the QoS in one of the following ways:

Entering the ISP and the service desired in the PPP/PPPoE dialer, during the session setup.

Choosing the ISP and the service from a portal.

Dial-Up Service Selection

For users connecting to the Internet via a dial-up client, the user selects the class of service via the PC dialer. There are two access protocols that are currently used by the DSL modem: PPPoA (PPP over ATM) and PPPoE.

PPPoA

For PPPoA dial-up service, the user selects the class of service specifying the class during the login process. Depending on the particular ISP, this may involve employing a Fully-Qualified Domain Name for the ISP.

For example, suppose the user is a subscriber of ISP.com and has a username of “john”, and that ISP.com has three pre-defined class-of-service access tunnels: “gold” for multimedia applications, “silver” for guaranteed bandwidth, and “bronze” for best effort (such as tunnels 24 in FIG. 2B). Each of these different class-of-service access tunnels has a different payment fee structure, such that the user pays a different price per connect-time unit or per transaction. For a multi-media application, the user would be willing to pay more for the highest QoS. For downloading a document, or for transactions that are not time-critical, however, the lowest-cost QoS is adequate and would be more cost-effective. When this user wants to connect to the Internet, he simply chooses the appropriate Login Name for the desired service: “john@gold.isp.com”, “john@bronze.isp.com”, or “john@silver.isp.com”.

The user can also choose other providers, such as an Application Service Provider (ASP). The ASP can determine the required QoS by itself so that the user may not need to explicitly specify the class of service. For example, the user could simply log onto “john@video-stream.com” and automatically be connected via the “gold” tunnel.

PPPoE

For PPPoE dial-up service, the protocol allows additional options for service selection via the “Service Tag” in the PPPoE protocol. By using a local menu at the dialer, the user can choose the desired service type. The information in the Service Tag can be user information as well as service information.

Portal-Based Service Selection

A portal may be generally thought of as a web page (or set of pages) that provides a single point of entry for a suite of web services. In the captive portal model, the Network Access Provider (NAP) allows the user to select the ISP and/or the class of service via a web portal that the user reaches prior initiating the actual login process. In order to support this, the provider distributes any required software directly to the end users.

FIG. 8 illustrates a portal server 83, which is located logically behind an edge router 82. A user 80 logs onto the carrier's network using a guest account session 85. An aggregator 81 connects user 80 to edge 82 router over a tunnel 87 that is specifically dedicated for guest access. Edge router 82 terminates the PPP and assigns user 80 a temporary IP address. Subsequently, when user 80 opens a web browser, all traffic therefrom is redirected to portal server 83, which places a menu on the displayed portal in the web browser. User 80 then chooses an ISP and/or class of service from this menu. A new session 84 is then established for user 80 according to the menu selection made. The way new session 84 is established may depend on the user protocol and the carrier's equipment. For a PPPoA connection, the user's dialer software may close current session 85 and open new session 84 with the user name and FQDN to specify the desired class of service (as described previously). For a PPPoE connection, the PPPoE dialer software may be used to open new session 84 with the appropriate Service Tag, and optionally close current session 85. In each case, new session 84 is connected by aggregator 81 to edge router 82 over an appropriate tunnel 88, such that tunnel 88 provides the requested or required class of service.

Service Rejection Notification

If the required resources are unavailable (for example, inadequate bandwidth in the specified tunnel or lack of bandwidth in the line between the DSLAM and the aggregator), the session is rejected. In this case, the user should be notified of the rejection. Furthermore, the edge router should also be notified of the rejection, because the edge router generally serves as the subscriber manager.

In an embodiment of the present invention, the aggregator connects the user to the edge router over a special tunnel herein denoted as a “reject tunnel”, over which the edge router sends a rejection notification to the user.

In another embodiment of the present invention, the aggregator sends a rejection notification to the user and to the edge router via a special out-of-band interface, such as the management system.

While the invention has been described with respect to a limited number of embodiments, it will be appreciated that many variations, modifications and other applications of the invention may be made.

1. In an IP service broadband access/transport network, a device comprising:
(a) a first set of ports for establishing user-side connections, via an access network, to a plurality of user workstations; and
(b) at least one second port for establishing a network-side connection, via a transport network, to at least one edge router for accessing the IP service, said network-side connection including a plurality of tunnels, each tunnel of which is designated for a unique quality of service, said plurality of tunnels configured to employ PPPoE, said tunnels configured to aggregate a plurality of PPP sessions per tunnel, and each tunnel being associated with a connection-oriented path;
the device being operative to dynamically allocating service and quality of service by dynamically connecting a connected user to said at least one edge router via a tunnel selected one from said plurality of tunnels.

2. The device of claim 1, configured to perform the following:
(a) identifying an incoming session from said user through said access network, determining the required transport service having the quality of service associated with said incoming session, and appropriately configuring the device if said required quality of service can be provided;
(b) forwarding said incoming session to an appropriate tunnel in said transport network according to the required quality of service; and
(c) aggregating a plurality of incoming sessions from users over a single tunnel, said plurality of incoming sessions having the same quality of service requirements, utilizing PPPoE and an associated connection-oriented path.

3. The device according to claim 1, wherein said transport network is an ATM network, and wherein said connection-oriented path utilizes Virtual Circuits.

4. The device according to claim 2, wherein said transport network is an ATM network, and wherein said connection-oriented path utilizes Virtual Circuits.

5. The device according to claim 1, wherein said transport network is an MPLS network, and wherein said connection-oriented path utilizes LSP.

6. The device according to claim 2, wherein said transport network is an MPLS network, and wherein said connection-oriented path utilizes LSP.

7. The device according to claim 1, being an aggregator.

8. The device according to claim 2, being an aggregator.

9. The device according to claim 3, being an aggregator.

10. The device according to claim 4, being an aggregator.

11. The device according to claim 5, being an aggregator.

12. The device according to claim 6, being an aggregator.

13. The device according to claim 1, being a DSLAM.

14. The device according to claim 2, being a DSLAM.

15. The device according to claim 3, being a DSLAM.

16. The device according to claim 4, being a DSLAM.

17. The device according to claim 5, being a DSLAM.

18. The device according to claim 6, being a DSLAM.

19. A method for setting up a session for a user over an access/transport network having a plurality of tunnels, wherein the session has a requirement selected from a group including a required service and a required quality of service, and wherein each tunnel of the plurality of tunnels has a specific class of service associated with a specific quality of service, the method comprising:
(a) determining the required quality of service;
(b) selecting a tunnel from the plurality of tunnels, such that the selected tunnel has a class of service appropriate to the required quality of service; and
(c) connecting the user session to said selected tunnel.

20. The method of claim 19, wherein the access/transport network has a BRAS, the method further comprising:
(d) initiating PPPoE discovery toward the BRAS.

21. The method of claim 20, further comprising:
(e) obtaining the access rights of the user; and
(f) performing an LCP proxy.

22. The method of claim 20, further comprising:
(e) sending a PADI packet;
(f) obtaining a service tag from said PADI packet; and
(g) utilizing said service tag to perform said selecting a tunnel from the plurality of tunnels, according to said service tag.

23. A method for obtaining a request for a desired service at the time of setting up a session for a user, the method comprising:
(a) initiating setup of the session;
(b) while the session is being set up, making an identification of the characteristics of the desired service; and
(c) receiving said identification.

24. A method for obtaining a request for a desired quality of service at the time of setting up a session for a user, the method comprising:
(a) initiating setup of the session;
(b) while the session is being set up, making an identification of the characteristics of the desired quality of service; and
(c) receiving said identification.

25. The method of claim 23, further comprising:
(d) notifying the user if the desired quality of service is not available.

26. The method of claim 23, further comprising:
(d) selecting a service provider; and
(e) entering a login name of the user.

27. The method of claim 26, further comprising:
(f) entering a fully-qualified domain name for said service provider.

28. The method of claim 23, wherein said selecting a quality of service is performed by the user from a portal.

29. A system for notifying a user of a rejection of a session, the system comprising:
(a) a plurality of tunnels; and
(b) a tunnel of said plurality dedicated to conveying a rejection message to the user.

30. A computer program product comprising machine-readable code operative to performing the methods of claim 19.

31. The computer program product of claim 30, further comprising storage for said machine-readable code.

32. The computer program product of claim 31, further comprising storage media associated with said storage.

33. A computer program product comprising machine-readable code operative to performing the methods of claim 23.

34. The computer program product of claim 33, further comprising storage for said machine-readable code.

35. The computer program product of claim 34, further comprising storage media associated with said storage.
